(19) United States
(12) Patent Application Publication
(10) Pub. No.: US 2014/0177747 A1
(43) Pub. Date: Jun. 26, 2014

(54) MIMO COMMUNICATION METHOD, MIMO TRANSMITTING DEVICE AND MIMO RECEVING DEVICE

(71) Applicant: Sharp Kabushiki Kaisha, Osaka (JP)

(72) Inventors: Alvaro RUIZ DELGADO, Osaka-shi (JP); Minoru KUBOTA, Osaka-shi (JP); Takashi ONODERA, Osaka-shi (JP); Hiromichi TOMEBA, Osaka-shi (JP)

(73) Assignee: Sharp Kabushiki Kaisha, Osaka (JP)

(21) Appl. No.: 14/133,690

(22) Filed: Dec. 19, 2013

(30) Foreign Application Priority Data
Dec. 20, 2012 (JP) 2012-278724

(51) Int. Cl. H04B 7/04; H04L 5/00

(52) U.S. Cl. CPC H04B 7/0413; H04L 5/0053
USPC 375/267

(57) ABSTRACT

The current feedback mechanisms in the 802.11 standard are not appropriate for MU-MIMO, in which many STAs transmit their feedback to an AP, which then proceeds to select the most appropriate STAs for transmission and discards the feedback of the rest of the STAs. This operation leads to large overhead, effectively limiting the effectivity of the MU-MIMO operation. The techniques described in this document allow for a more efficient transmission of feedback related to a MIMO communication.

In this invention a double step feedback method is proposed trough which the STAs first transmit a reduced feedback enabling the AP to perform scheduling, and then the STAs that are chosen for scheduling transmit complementary feedback for the only the streams that are chosen by the scheduling operation. This operation results in a much more efficient feedback transmission.

### TECHNICAL FIELD

This invention relates to a MIMO communication method, MIMO transmitting device and MIMO receiving device.

### BACKGROUND ART

There are many instances in which a transmitting wireless communication access point (from now on AP) benefits from knowing the characteristics of the channel between the antennas at the AP and the antennas at the receiving wireless communication station (from now on STA).

This information can give the AP the capacity to perform precoding, modifying a signal in a way that it will be perceived by the STA as interference free after going through the channel. Precoding can be used for single antenna operation or multi-input multi-output operation (MIMO), either for the single user case (SU-MIMO) or the multi-user case (MU-MIMO), in which the STA transmits information to multiple antennas belonging to different STAs.

The information about the condition of the channel can serve other purposes, e.g. the AP chooses the STAs to which to transmit according to their current channel conditions, etc. The AP considers a set of possible streams and selects the subset that the AP reckons as the best group according to some parameters established previously.

Current systems are not flexible enough to escalate appropriately with the number of antennas at reception side, especially when systems such as MU-MIMO are considered, in which antennas from different STAs can be selected. In order to perform this selection, the AP requires channel information from all the streams reaching the antennas of all the involved STAs. Detailed channel knowledge is required to avoid interference between the different streams, but the stream selection process can be performed satisfactorily with much less detail. However, in order to perform an adequate interference cancellation, a high level of detail is required. Current techniques don't differentiate between these two needs, resulting in a big overhead due to the detailed feedback of many streams that are discarded.

The embodiments of the invention included in this document are explained taking as a baseline example the 802.11 standard in its current form (non-patent reference 1) and relevant amendments such as 11ac (non-patent reference 2). In particular, the relevant parts are explicit feedback and MIMO operation, which are mainly explained in section 20 of non-patent reference 1 and in section 22 of non-patent reference 2. Further details will be given in the embodiments below. This is chosen as reference, and it is noteworthy that the embodiments of the invention are not limited to this standard.

It's important to note that in this document the concept of antenna is taken as the device or set of devices that allow the transmission or reception of one stream. That is, in this document, a STA that can transmit or receive up to one stream is considered as being furnished with one antenna; a STA that can transmit or receive up to two streams is considered to be furnished with two antennas; etc.

### CITATION LIST

### Non Patent Literature

[NPL 1] IEEE 802.11-2012 (Revision of IEEE Std 802.11-1999), March 2012
[NPL 2] IEEE P802.11ac/D3.0, June 2012

### SUMMARY OF INVENTION

### Technical Problem

In a MIMO communication system, AP can send different data through different streams at the same time by preparing the transmitted signal in a way that results in no interference being perceived by the receiver of each stream. In order to perform this operation, AP requires a good knowledge of the channel between AP and each antenna of a receiver involved in the communication. The importance of AP having a good representation of the channel is accentuated for MU-MIMO systems, especially the ones based on non-linear techniques, which can achieve a higher data rate than the relatively simple linear techniques, but are more sensitive to channel estimation errors. Furthermore, AP reaps diversity benefits by knowing the state of more streams than it can simultaneously transmit to, being enabled to choose an optimal or sub-optimal STA configuration.

AP receives feedback from many STAs, each including data for every possible communication stream between each antenna at AP and each antenna at the STA. As the antennas at both the STAs and AP become more numerous, the number of possible streams increases geometrically (each antenna of AP sees one possible stream to each of the antenna of the STAs). This deepens the impact of the feedback in the overhead, and hinders the overall efficiency of the system.

Some solution is required to allow the leveraging of multiple antennas at both receiver and transmitter without incurring into a penalty to the throughput.

### Solution to Problem

The present invention has been made to solve the above-described problem. According to an embodiment of the present invention, the feedback of the channel state information from the receiving devices to the transmitting device is given in two steps of rough and complementary feedbacks in a MIMO communication.

### Advantageous Effects of Invention

The embodiments of the invention allow for a more efficient use of the feedback.

### BRIEF DESCRIPTION OF DRAWINGS

FIG. 1 shows an example MIMO communication system.

FIG. 2 shows an exemplary case for “rough” and “complementary” feedback information.

FIG. 3 FIG. 3 shows a sounding process in which the feedback is given to AP in two steps.

FIG. 4 shows an exemplary table with a code to inform about the level of feedback.

FIGS. 5A and 5B show more examples of how the number of bits corresponding to the “rough” feedback and the “complementary” feedback can be coded.

FIG. 6 shows one more example in which the number of rough and complementary bits is given by a single code.

FIG. 7 shows one example of the block diagram for AP according to Embodiment 1.

FIG. 8 shows one example of the block diagram for STA according to Embodiment 1.

### DESCRIPTION OF EMBODIMENTS

Now, preferred embodiments of the present invention will be described in detail with reference to the annexed drawings. The embodiments relate to a WLAN (Wireless Local Area Network), but they are not restricted to the WLAN, but are also applicable to a mobile phone network.

### Embodiment 1

This embodiment takes the MU-MIMO transmission as the baseline case, but it is not constrained to it and can also be used with other systems that require feedback from different streams.

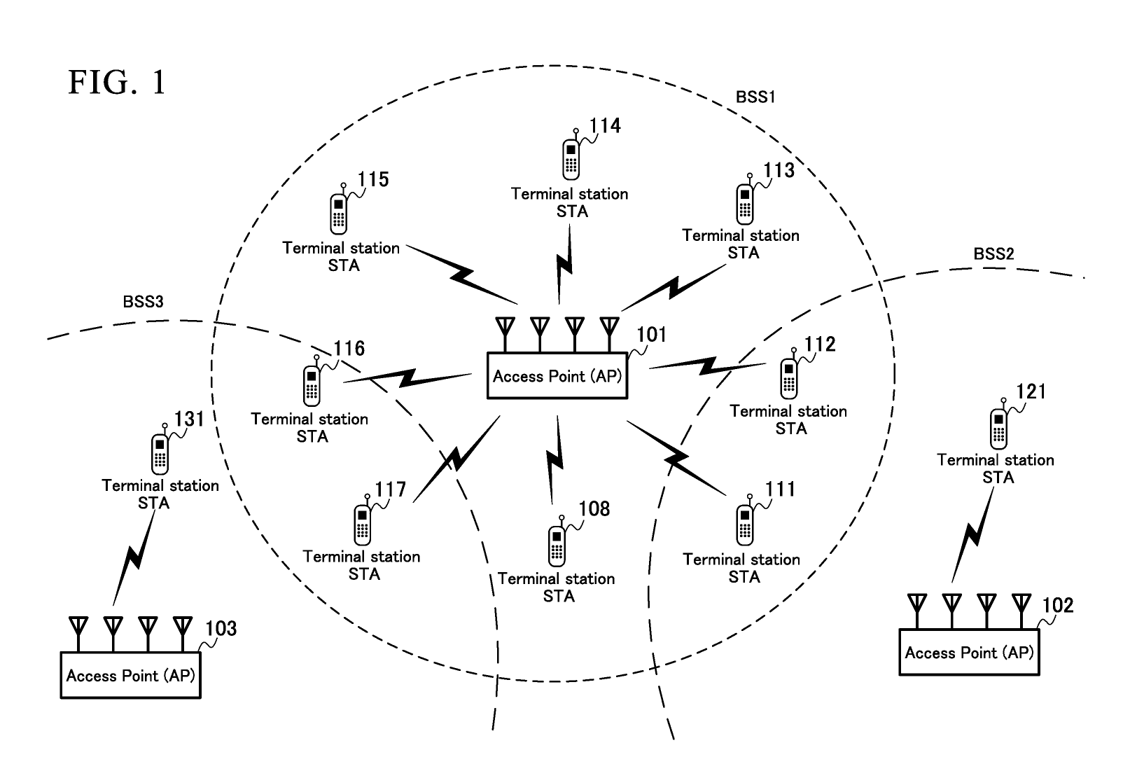

FIG. 1 shows an example wireless system. AP 101 acts as the AP of the basic service set BSS 1. AP 101 can communicate with STAs 111 to 118.

AP 101 may be endowed with many antennas that are capable of inputting different signals into the medium at the same time and in the same frequency bandwidth through spatial multiplexing (multiple input multiple output, MIMO). If the STA also has multiple antennas, AP 101 can transmit different data stream from each antenna at AP 101, each stream targeting a different STA antenna (single user MIMO, SU-MIMO). Alternatively, AP 101 can transmit different data streams to different antennas that may belong to different STAs (multiuser MIMO, MU-MIMO).

In this example, AP 101 and STAs 111 to 118 belong to BSS1 (Basic Service Set). BSS2 is also shown, comprising AP 102 and STA 121. The emissions of AP 102 are also received by STAs 111 and 112. Similarly, BSS3 comprises AP 103 and STA 131. The emissions of AP 103 are also received by STAs 116 and 117.

However, the STAs to which the MU-MIMO multiplexed signals are addressed perceive the signal intended to other signals as multiuser interference (MUI), which leads to a performance degradation in bandwidth. In order to restrain the MUI, the STAs send feedback information about the channel to AP 101, which performs precoding, altering the signal in a way that after passing through the channel the signal will be seen as interference free by the receiving STAs.

Usually, AP 101 can select freely the antennas to perform MU-MIMO among all the antennas of all the STAs. However, in some cases, the possibilities of which STAs can be multiplexed together in an MU-MIMO communication are artificially limited to a predetermined set. This set can be changed to reflect variations in the environment leading to higher perceived synergy groups, or to reflect the appearance and disappearance of STAs in the BSS, but the set remains fixed for a relatively long period of time, and therefore it is not possible to alter them at convenience at the transmission instant. In this document, the present embodiments capture both situations, but the text assumes a restricted set limitation working hypothesis.

A well-known way of performing precoding is by singular value decomposition (SVD). Equation 1 shows the singular value decomposition of the channel H.

[Equation 1]

H_{Nr×Nt}=U_{Nr×Nr}·S_{Nr×Nt}·V_{Nt×Nt}^{H} (1)

In the above equation, U and V are unitary matrices, S is a diagonal matrix of singular values, Nr is the number of antennas at the STA, Nt is the number of antennas at AP 101, and V^{H} is the Hermitian (complex conjugate transpose) of V.

The signal received by the STA is shown in equation 2

[Equation 2]

Y=H·x+η (2)

In the above equation, H is the channel matrix between the transmitting antennas and the receiving antennas, x is the signal transmitted by AP 101, and η is the noise as seen by the STAs.

AP 101 pre-multiplies the transmitted signal by the matrix V as in equation 3.

[Equation 3]

Y=H·x′+θ=H·V·x+η=(U·S·V^{H})·V·x+η=U·S·x+η (3)

In the above equation, x′ is the signal to be transmitted by AP 101 after precoding.

At reception, the STA pre-multiplies Y by the hermitian of the matrix U as in equation 3a.

[Equation 3a]

Y′=U^{H}·Y=U^{H}·(H·x′+η)=U^{H}·H·V·x+U^{H}η=U^{H}·(U·S·V^{H})·V·x+η′=S·x+η′ (3a)

In the above equation, Y′ is the received signal Y after pre-multiplying by U^{H}, and the resulting noise 1 is equivalent to the original noise factor II, being the matrix U^{H} unitary and therefore not affecting the magnitude of the noise.

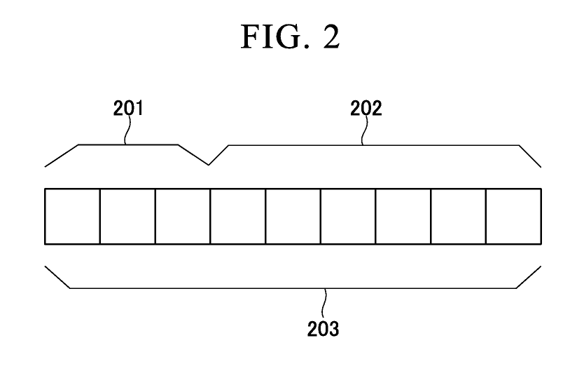

FIG. 2 shows an exemplary case for “rough” and “complementary” feedback information. Regardless of the feedback type, the STA performs quantization of some values to send them back to AP 101. Full quantized value 203 (Q_{full} bits) corresponds to all the N_{full} bits resulting of the quantization operation. Rough 201 (Q_{rough}), the result of quantizing that value with a lower bit count is given by the first N_{rough} most significant bits of the Full quantized value 203. Rough 201 is sent as feedback to allow AP 101 to select the MU-MIMO group. Complementary 202 (Q_{complementary}) comprises the N_{complementary} least significant bits of the full quantized value, where N_{full}=N_{complementary}+N_{rough}. These bits are sent to AP 101 as “complementary” feedback. AP 101 can then use them in combination with the previously acquired N_{rough} bits to obtain the Full quantized value (by appending them as least significant bits of the “rough” bits).

Notice that Q_{full} is not constrained to the values that are considered in the current specifications. Given that in the first step only N_{rough} bits are transmitted, the number of bits of the full value N_{full}=N_{rough}+N_{complementary} can be larger than the current standards specifications (therefore providing more accuracy) and still result in a communication with less overhead.

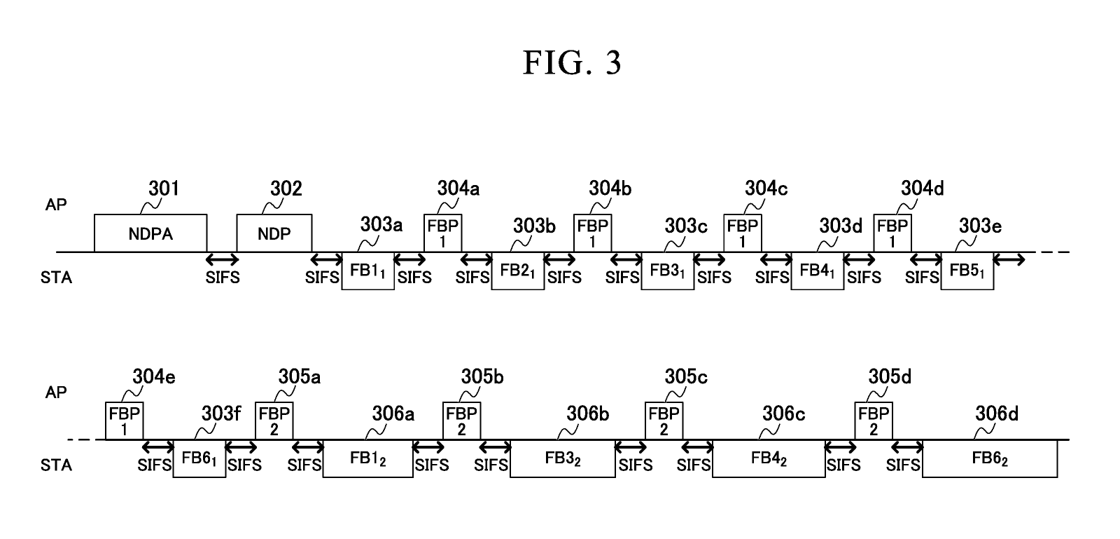

FIG. 3 shows a sounding process in which the feedback is given to AP 101 in two steps. In FIG. 3, NDPA (No Data Packet Announce) 301 transmitted by AP 101 announces that the next frame is going to be a sounding NDP (No Data Packet). It contains STA Info fields announcing the STAs that are expected to compute and return the feedback. Additionally, there is a mechanism to indicate that the type of feedback that is expected is “rough” feedback. NDP 302 contains no data, and it serves to sound the whole channel bandwidth independently for each of the AP's N_{T} antennas. Each STA estimates the complex gains corresponding to the streams between each of their N_{R} receiving antennas and each of the N_{T} transmitting antennas at AP 101. These values form the channel matrix H.

The first STA as identified by NDPA 301 (its STA Info field is the first in the NDPA), sends its “rough” feedback through FB1₁ 303a. If the feedback information is not received correctly, FBP₁ 304a asks for its retransmission. If the feedback information is received correctly, FBP₁ 5104a addresses the next STA to send its “rough” feedback. FBP₁ 304a contains a STA Info field to address the next direction and indicating that the desired feedback is the “rough” version of the channel information. FB2₁ 303b answers FBP₁ 304a with the appropriate “rough” feedback. This process continues until AP 101 has received correctly the “rough” feedback of all the considered STAs.

AP 101 selects the STAs to be part of the MU-MIMO group based on the received “rough” feedback of all the STAs, and sends FBP₂ 305a addressing the first of these STAs requesting “complementary” channel information. The STA sends the “complementary” channel information in FB1₂ 306a. If FB1₂ 306a is not received correctly, FBP₂ 305b requests retransmission of the parts that are not correct. If FB1₂ 306a is received correctly, FBP₂ 305b addresses the next STA part of the MU-MIMO group and requests “complementary” channel information. FB3₂ 306b conveys the pertinent information, and the process continues until all the STAs in the MU-MIMO group have sent their “complementary” channel information. It is of interest to consider that one STA may be selected for more than one stream, resulting in less STAs conveying their detailed channel information than streams can be transmitted by AP 101.

The frames sent by the AP 101 must indicate what kind of feedback is expected from the STA. That information can be part of the VHT MIMO control, the feedback poll, etc.

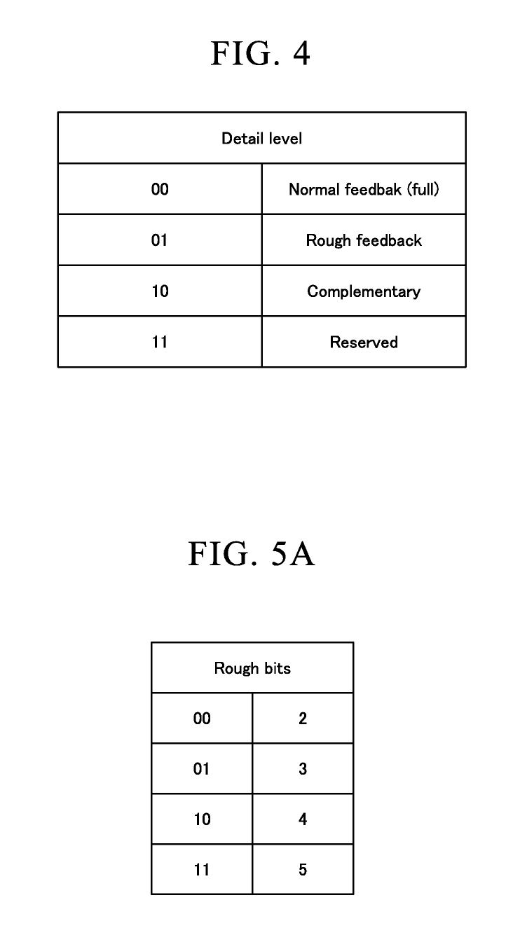

FIG. 4 shows an exemplary table with a code to inform about the level of feedback that is requested, with the options being normal feedback (full), rough feedback or complementary feedback. Additionally, a value is reserved for future uses.

In the following, the three feedback cases of the exemplary standard 802.11 [1, 2] are explained, along with the modifications required to Implement the feedback style explained above. This cases are CSI feedback, non-compressed beamforming feedback, and compressed beamforming feedback. This doesn't restrict the embodiments of the invention to these cases.

If the feedback style is CSI, the STA sends AP 101 the channel matrix H(k) as the STA perceives it (being ‘k’ the subcarrier index). AP 101 computes the beamforming weights matrix necessary to precode the signal.

The STA transmits the SNR as perceived by each STA antenna and the quantized values along with the 3 bits that identify the scale employed for each subcarrier channel matrix (indicating the proportion of the channel matrix of the corresponding subcarrier to the highest value among the matrices of all subcarriers, as explained in reference 1). The total amount of bits sent for CSI feedback can be calculated as described by equation 4.

[Equation 4]

feedback_{CSI}=N_{R}·8+N_{S}·(3+2·N_{b}·N_{R}·N_{T}) (4)

In the above equation, N_{R} represents the number of antennas at STA, N_{S} represents the number of subcarriers for which the feedback information is sent, N_{b} represents the number of quantization bits, and N_{T} represents the number of antennas that were employed for sounding at AP 101.

The “rough” CSI feedback corresponds to the most significant values of each element of the quantized channel matrix. Apart from the channel values, the CSI feedback also contains the SNR perceived by each antenna, and a scale value per subcarrier. It is not necessary to send these values as part of the “complementary” feedback. Equation 5 shows the feedback size for the “rough” and “complementary” versions of the CSI feedback.

[Equation 5]

feedback_{CSI}_{_{ROUGH}}=N_{R}·8+N_{S}·(3+2·N_{ROUGH}·N_{R}·N_{T})

feedback_{CSI}_{_{COMPLEMENTARY}}=N_{S}·(2·N_{COMPLEMENTARY}·N_{R}·N_{T}) (5)

In the above equation, N_{ROUGH} is the number of most significant bits chosen for conveying the “rough” feedback, and N_{ROUGH} is the number of remaining least significant bits.

In the case of non-compressed beamforming feedback, the STA computes the value of the beamforming weights and sends these values to AP 101. This matrix may be for example the matrix V resulting from the singular value decomposition (SVD). Other techniques are also allowed, as the STA has control over both the beamforming matrix creation and its detection process. The embodiments of this invention cover all these possibilities, but for brevity the rest of the document refers to singular value decomposition as the main example.

The STA transmits the SNR corresponding to each transmission stream as perceived by the STA antenna, and the quantized values of the beamforming weight matrix. The total amount of bits sent for feedback can be calculated as described by equation 6.

[Equation 6]

feedback_{non-compressed}=N_{T}·8+N_{S}·(2·N_{b}·N_{R}·N_{T}) (6)

In the above equation, N_{R} represents the number of antennas at STA, N_{S} represents the number of subcarriers for which the feedback information is sent, N_{b} represents the number of quantization bits (2, 4, 6 or 8 for non-compressed beamforming report), and N_{T} represents the number of antennas that were employed for sounding at AP 101.

The “rough” non-compressed feedback corresponds to the most significant values of each element of the quantized channel matrix. Apart from the matrix values, the non-compressed feedback also contains the SNR perceived for each stream. It is not necessary to send these values as part of the “complementary” feedback. Equation 7 shows the feedback size for the “rough” and “complementary” versions of the non-compressed feedback.

[Equation 7]

feedback_{non-compressed}_{_{ROUGH}}=N_{T}·8+N_{S}·(2·N_{ROUGH}·N_{R}·N_{T})

feedback_{non-compressed}_{_{COMPLEMENTARY}}=N_{S}·(2·N_{COMPLEMENTARY}·N_{R}·N_{T}) (7)

In the case of compressed beamforming report, the computation of the complementary feedback is a bit more complicated. This process is based on performing Givens reduction to the beamforming weights matrix V.

After this operation is performed, the resulting angles ψ and φ are quantized as shown in equation 8.

$$\begin{matrix}[ Equation 8 ] & \\ ψ = \frac{k \cdot π}{{2}^{{b}_{ψ} + 1}} + \frac{π}{{2}^{{b}_{ψ} + 2}} radians \text{/} k = 0 , 1 , … , {2}^{{b}_{ψ}} - 1 \\ φ = \frac{k \cdot π}{{2}^{{b}_{φ} + 1}} + \frac{π}{{2}^{{b}_{φ}}} radians \text{/} k = 0 , 1 , … , {2}^{{b}_{φ}} - 1 & ( 8 )\end{matrix}$$

In the above equation, b_{ψ} represents the quantization bits used for the angles ψ, and b_{φ} represents the quantization bits used for the angles φ.

AP 101 reconstructs the matrix \tilde{V} and uses it as the beamforming weights matrix. Equation 9 shows an example for a 4×2 case.

[Equation 9]

\tilde{V}=V·\tilde{D}*=D₁·G₂₁^{T}(ψ₂₁)·G₃₁^{T}(ψ₃₁)·G₄₁^{T}(ψ₄₁)·D₂·G₃₂^{T}(ψ₃₂)·G₄₂^{T}(ψ₄₂)·Ĩ_{4×2} (9)

The beamformed matrix is still affected by a rotation matrix \tilde{D}*. The STA can estimate the value of this rotation and use it to undo the rotation and obtain the intended data signal. The total amount of bits sent for feedback can be calculated as described by equation 10.

[Equation 10]

feedback_{compressed}=N_{T}·8+N_{S}·(Nₐ·(b_{ψ}+b_{φ})/2) (10)

In the above equation, N_{T} represents the number of antennas at AP, N_{S} represents the number of subcarriers for which the feedback information is sent, Nₐ is the number of angles to be sent per subcarriers, b_{ψ} represents the quantization bits used for the angles ψ, and b_{φ} represents the quantization bits used for the angles φ (the duple (ψ, φ) can take the values (1, 3), (2, 4), (3, 5) or (4, 6) for the compressed beamforming report).

In the case of compressed feedback, the quantized values correspond to the Givens rotation angles ψ and the conditioning angles φ resulting from the Givens decomposition of the precoding matrix V. Apart from the angular values, the compressed feedback also contains the SNR perceived for each stream. It is not necessary to send these values as part of the “complementary” feedback. Equation 11 shows the feedback size for the “rough” and “complementary” versions of the compressed feedback.

[Equation 11]

feedback_{compressed}_{_{ROUGH}}=N_{T}·8+N_{S}·(Nₐ·(b_{ψ}_{_{ROUGH}}+b_{φ}_{_{ROUGH}})/2)

feedback_{compressed}_{_{COMPLEMENTARY}}=N_{S}·(Nₐ·(b_{ψ}_{_{COMPLEMENTARY}}+b_{φ}_{_{COMPLEMENTARY}})/2) (11)

In the case of compressed MU-MIMO feedback, the quantized values correspond to the Givens rotation angles ψ and the conditioning angles φ resulting from the Givens decomposition of the precoding matrix V. Apart from the matrix values, the compressed feedback also contains the SNR perceived for each stream and the SNR deviation from the average SNR corresponding to each subcarrier. It is not necessary to send these values as part of the “complementary” feedback. Equation 12 shows the feedback size for the “rough” and “complementary” versions of the compressed feedback.

$${feedback}_{{compressed}_{MU \text{-} {MIMO}_{ROUGH}}} = {N}_{T} \cdot 8 + {N}_{S} \cdot ( {N}_{a} \cdot \frac{( {b}_{{ψ}_{ROUGH}} + {b}_{{φ}_{ROUGH}} )}{2} ) + 4 \cdot {N}_{T} \cdot {N}_{S} \\ {feedback}_{{compressed}_{MU \text{-} {MIMO}_{COMPLEMENTARY}}} = {N}_{S} \cdot ( {N}_{a} \cdot \frac{( {b}_{{ψ}_{COMPLEMENTARY}} + {b}_{{φ}_{COMPLEMENTARY}} )}{2} ) \qquad [ Equation 12 ]$$

In the case of MU-MIMO, knowing the average SNR corresponding to each stream is not enough, more detail is required. This is done by adding a special MU-Exclusive Beamforming Report, giving the deviation of the SNR corresponding to each subcarrier with respect to the average SNR of the stream. This deviation is calculated as in equation 13.

$$\begin{matrix}[ Equation 13 ] & \\ {SNR}_{k , i} = 10 \cdot {log}_{10} ( \frac{{‖ {H}_{k} \cdot {V}_{k , i} ‖}^{2}}{N} ) & ( 13 )\end{matrix}$$

In the above equation, V_{k,i} is the i^{th} column of the feedback beamforming matrix at subcarrier k, and N is the noise plus interference power measured at the beamformer.

The STA transmits the SNR as perceived by each STA antenna, the quantized angle values that correspond to the Givens rotation reduction of the beamforming weights matrix V of each subcarrier, and the MU-Exclusive Beamforming Report stated above. The total amount of bits sent for feedback can be calculated as described by equation 14.

[Equation 14]

feedback_{compressed}_{_{MU-MIMO}}=N_{T}·8+N_{S}·(Nₐ·(b_{ψ}+b_{φ})/2)+4·N_{T}·N_{S} (14)

In the above equation, N_{T} represents the number of antennas at AP, N_{S} represents the number of subcarriers for which the feedback information is sent, Nₐ is the number of angles to be sent per subcarriers, b_{ψ} represents the quantization bits used for the angles ψ, and b_{φ} represents the quantization bits used for the angles φ (the duple (ψ, φ) can take the values (5, 7) or (7, 9) for the compressed beamforming report in the MU-MIMO case).

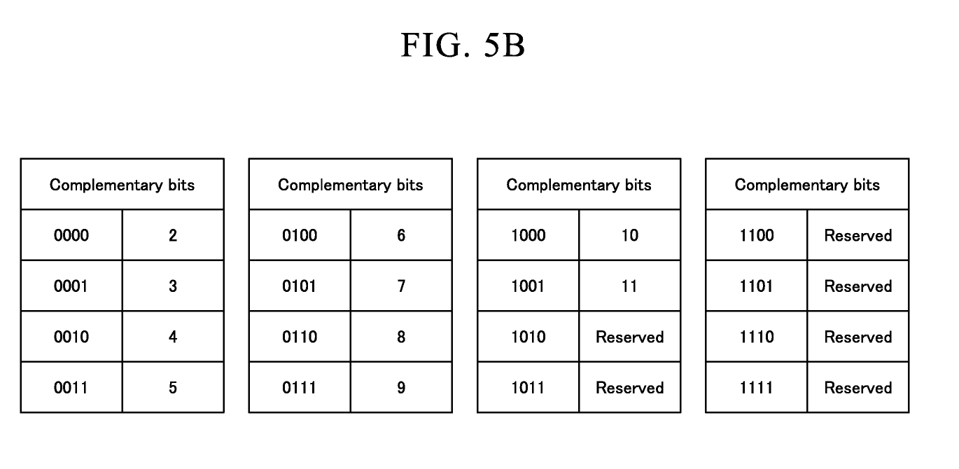

FIG. 5A and FIG. 5B show more examples of how the number of bits corresponding to the “rough” feedback and the “complementary” feedback can be coded, with two bits for “rough” feedback and four bits for “complementary” feedback.

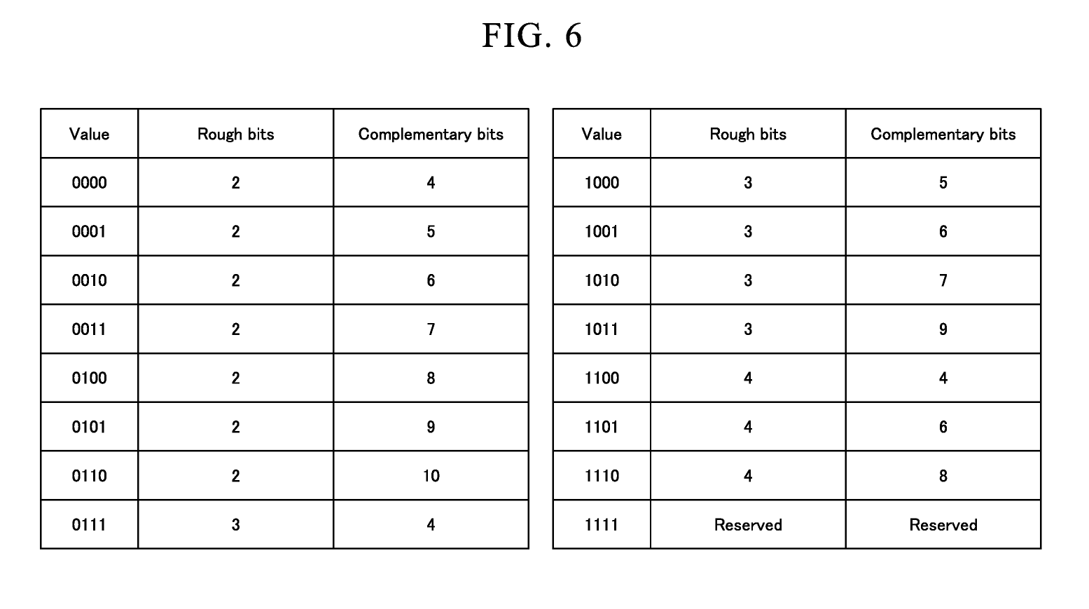

FIG. 6 shows one more example in which the number of rough and complementary bits is given by a single code.

These are examples of STA Info. Other configurations that follow the same spirit are also included. For instance, in any of them, the values of the fields representing the quantization bits for the “rough” and “complementary” case could be different according to the feedback style, etc.

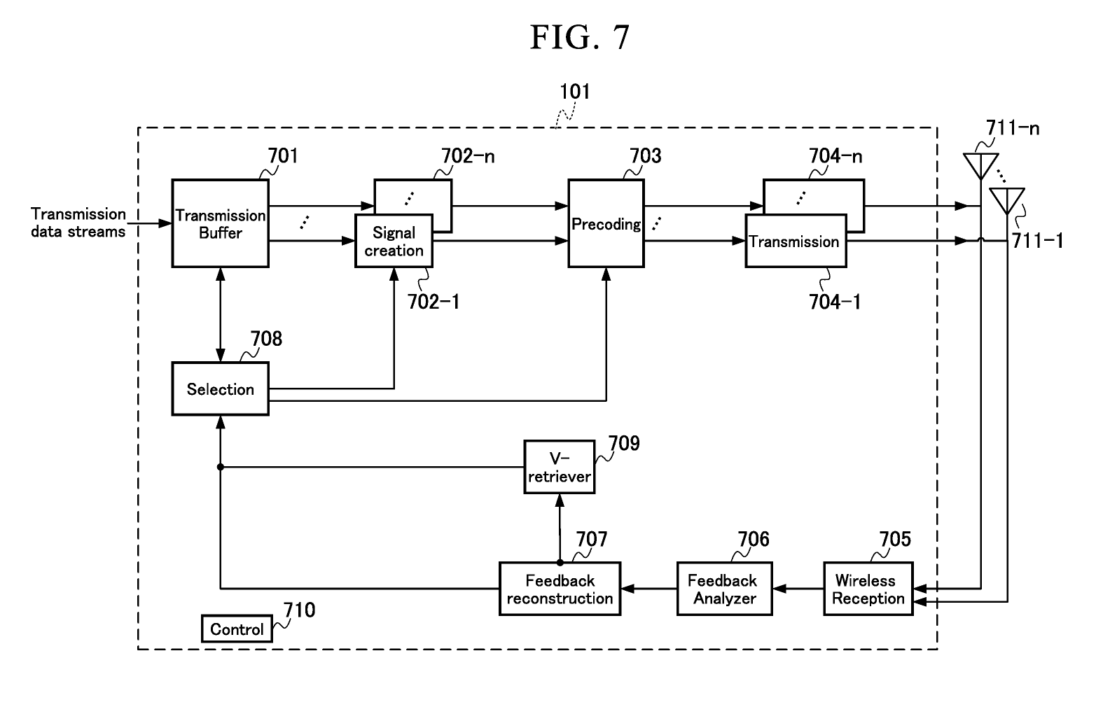

FIG. 7 shows one example of block diagram for AP 101.

Wireless reception 705 receives the data transmitted from each STA (in which the first STA is STA 111 in FIG. 1) arriving at antenna module 711-1 to 711-n, and after down-conversion and AD (analogue to digital) conversion outputs the signals including the feedback information to Feedback analyzer 706.

Feedback analyzer 706 extracts the feedback information from each of the data streams received from STAs.

Feedback reconstruction 707 receives the feedback values from Feedback analyzer 706. If Control 710 indicates full quantized value operation, Feedback reconstruction 707 gives the feedback without modification to V retriever 709. If Control 710 indicates “rough” feedback operation, Feedback reconstruction 707 stores the feedback values and gives the feedback without modification to V retriever 709. If Control 710 indicates “complementary” feedback operation, Feedback reconstruction 707 retrieves the previously stored corresponding “rough” feedback and appends the received “complementary” bits as the least significant bits to improve the precision of the feedback, giving this reconstructed feedback to the V retriever 709 module. Feedback reconstruction 707 gives the SNR feedback information to Selection 708.

V retriever 709 obtains the V matrix (equations 1-4) from the feedback information. In the case of CSI feedback, V retriever 709 computes the singular value decomposition of the received matrix to obtain V. In the other cases, the received feedback information is already the matrix V.

Selection 708, stores the V matrices corresponding to one or more STAs obtained by V retriever 709. The V matrices are useful to determine the combination of receiving antennas that are more appropriate for MU-MIMO transmission, independently of which STA they belong to (being it because they present better orthogonality, or more power efficiency, etc.). Selection 708 could find some constraints, as for instance the existence of a limited set of groups of STAs. Based on these V matrices and the SINR feedback information given by Feedback reconstruction 707, Selection 708 selects a group with potentially many affiliated STAs to perform MU-MIMO and creates the appropriate combined V. Selection module 708 informs of the identity of these STAs to Transmission Buffer 701 to prepare the appropriate data, the combined V to Precoding 703 and their corresponding antennas to Signal creation 702-1 to 702-n. Furthermore, in the exemplary case presented in this embodiment, the selected group is always going to be one in which the first, second, third and fourth stream correspond to STAs 111 to 114 respectively.

Transmission buffer 701 stores the transmission data streams coming from upper layers that is intended to be transmitted to STAs, and conveys it to Signal creation 702-i as indicated by Selection 708, which takes care of addressing each data stream 1 to n to its corresponding STA. The number ‘i’ is either of 1 to n.

Signal creation 702-i performs forward error correction to the data coming from transmission buffer 701. Furthermore, it performs rate matching (through puncturing) to adapt the coding rate to the rate selected by Selection 708 for each of the data streams. Afterwards, modulated streams are created by modulating the resulting streams and the pilot symbols are multiplexed with them.

Precoding 703, having as an input the modulated streams addressed to STAs respectively to which the pilot signals have been inserted, and the matrix V from V retriever 709, performs precoding to those streams.

Transmission 704-i performs IFFT (Inverse Fast Fourier Transform) to each of the precoded streams (OFDM (Orthogonal Frequency Division Multiplexing) streams), inserts the guard interval (GI), carry out DA (digital to analog conversion) and frequency conversions and transmits from Antenna 711-i each of the streams.

Control 710 processes the necessary actions for the above mentioned modules.

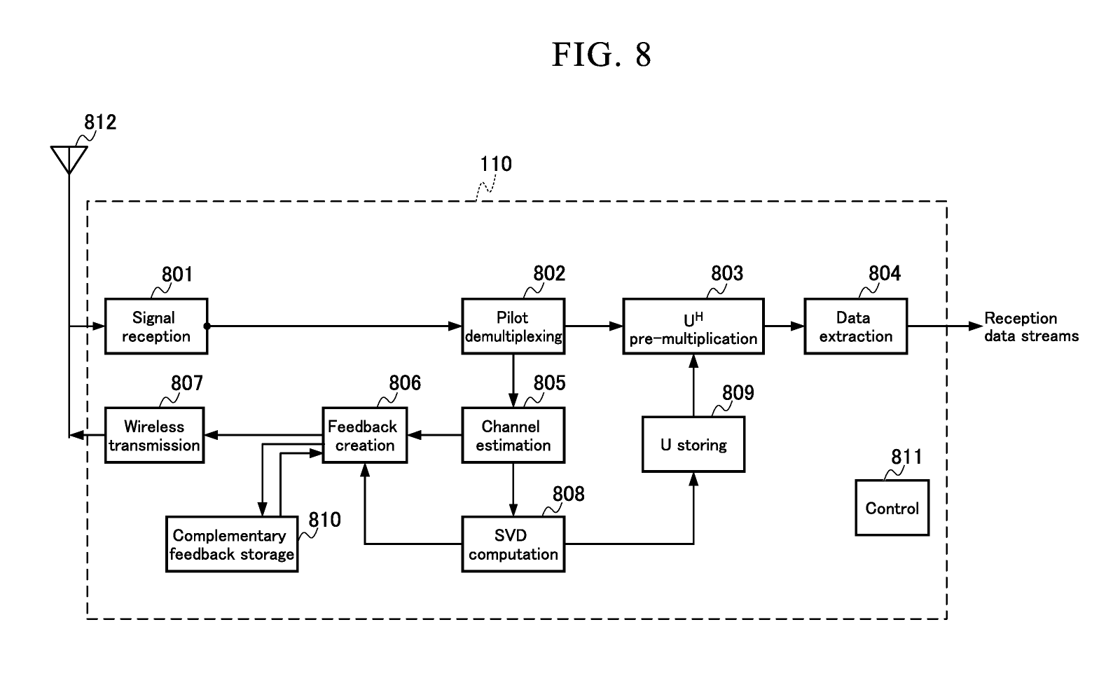

FIG. 8 shows one example of the STA.

Signal reception 801 handles the data streams from AP 101 received in Antenna 812, extracts the guard interval from the received signal after down-conversion to the baseband and AD conversion, and applies Fast Fourier Transformation (FFT) to change the signal to the frequency domain.

Pilot demultiplexing 802 extracts the pilot symbols from the frequency domain signal. It conveys these pilot signal values to Channel estimation 805 and the signal without the pilot symbols to U^{H} pre-multiplication 803. The subcarriers that appear in a prefixed configuration in training fields are considered as pilot symbols in this document.

Channel estimation 805, based on the values of the extracted pilot symbols, estimates the quality of the transmission with regard to the SNR perceived by each Antenna 812 from each transmitting antenna at AP 101.

SVD computation 808 performs the singular value decomposition of the channel estimated by Channel estimation 805. It outputs the computed matrix V to the Feedback creation 806 and the value of U to U storing 809.

U storing 809 stores the values of the matrix U as calculated by SVD computation 808 to be used by U^{H} pre-multiplication 803 when the signal has been precoded at AP 101 by its matching previously fed back V, as indicated by Control 811.

U^{H} pre-multiplication 803 pre-multiplies the received data symbols by the hermitian of the appropriate singular value decomposition U matrix stored in U storing 809 and identified by Control 811.

Data extraction 804 demodulates the data symbols output by U^{H} pre-multiplication 803 and performs error correction to the demodulated data streams, retrieving the reception data streams.

Feedback creation 806, based on the type of feedback to be sent as indicated by Control 811, estimates the SNR and creates the feedback to be transmitted to AP 101, using the results from the Channel estimation 805 and in some cases the resulting V coming from the SVD computation 808. For full quantized value operation, Feedback creation 806 gives the full feedback information to Wireless transmission 807. In case Control 811 indicates “rough” feedback, Feedback creation 806 creates the “rough” feedback and the “complementary” feedback, giving the “rough” feedback to Wireless transmission 807 and the “complementary” feedback to Complementary feedback storage 810. In case Control 811 indicates “complementary” feedback, Feedback creation 806 retrieves from Complementary feedback storage 810 the pertinent stored “complementary” feedback, and gives it to Wireless transmission 807.

Complementary feedback storage 810 stores the “complementary” feedback when the required feedback to be transmitted is the “rough” feedback. The “complementary” feedback may be accessed at a future time by “Feedback creation” 806. Wireless transmission 807 transmits the prepared feedback through Antenna 812 to AP 101.

Control 811 processes the necessary actions for the above mentioned modules.

### Embodiment 2

Embodiment 2 of this invention is a communication system as the one proposed in the embodiment 1 in which AP 101a of Embodiment 2, after selecting which streams are going to be used for the MIMO communication, requests the corresponding STAs the “complementary” feedback of only those specific streams, avoiding the transmission of “complementary” feedback information of unused streams.

In AP 101a, Feedback reconstruction module receives information about the streams addressed by the “complementary” feedback received from Feedback Analyzer module and takes it into account in order to reconstruct the feedback. Before performing its normal operation as explained in the embodiment 1, Feedback reconstruction module appends to the previously received “rough” feedback bits the received “complementary” feedback bits as least significant bits, and pads the rest of the values whose “complementary” feedback bits have not been received with zeros to achieve a homogeneous size distribution. Feedback reconstruction module then proceeds to its normal operation as described above.

In the STA, Feedback creation module receives information from Control module about which STA antenna “complementary” feedback is required. Feedback creation module retrieves the “complementary” feedback values from Complementary feedback storage module, selects the appropriate values, and gives them to Wireless transmission module. Depending on the feedback scheme, the method of preparing the appropriate values varies.

In the case of CSI feedback, the channel matrix H has dimensions N_{R}×N_{T}, where N_{R} corresponds to the number of streams the STA can receive (or number of independent antenna sets), and N_{T} corresponds to the number of streams AP 101a can transmit (or number of independent antenna sets). The “complementary” feedback for selected reception streams corresponds to the Q_{complementary} immediately after the most significant Q_{rough} bits of the quantized rows associated to those streams. Equation 15 shows the feedback size for the selected “complementary” version of the CSI feedback.

[Equation 15]

feedback_{CSI}_{_{SELECTED-COMPLEMENTARY}}=N_{S}(2·N_{COMPLEMENTARY}·SEL_{R}N_{T} (15)

In the above equation, SEL_{R} gives the number of streams whose “complementary” feedback is given.

In the case of non-compressed feedback, the precoding matrix V has dimensions N_{T}×N_{T}. The “complementary” feedback for the selected reception streams consists of the N_{complementary} immediately after the most significant N_{rough} bits of the columns associated to the same channel eigenvalues as the selected streams. Depending on the conditions, this may be achieved by selecting the columns with the same relative ordering as the requested streams, e.g. the columns 2 and 3, if the selected streams are the streams 2 and 3 (both starting from 1). Equation 16 shows the feedback size for the selected “complementary” version of the non-compressed feedback.

[Equation 16]

feedback_{non-compressed}_{_{SELECTED-COMPLEMENTARY}}=N_{S}·(2·N_{COMPLEMENTARY}·SEL_{R}·N_{T}) (16)

In the above equation, SEL_{R} gives the number of streams whose “complementary” feedback is given.

In the case of compressed feedback, the feedback values are the conditioning and Givens angles that come as a result of the Givens decomposition. AP 101a reconstructs the precoding matrix V with these angles.

The minimum required angles to reconstruct a column of the precoding V matrix depend on the column index. The Givens decomposition is an iterative process in which each step is performed over the results of the previous steps. To reconstruct the matrix, the process is done in the opposite order. Equation 17 shows an example of reconstruction for a 5×5 V matrix.

[Equation 17]

\tilde{V}=V·\tilde{D}*=D₁·G₂₁^{T}(ψ₂₁)·G₃₁^{T}(ψ₃₁)·G₄₁^{T}(ψ₄₁)·G₅₁^{T}(ψ₅₁)·D₂·G₃₂^{T}(ψ₃₂)·G₄₂^{T}(ψ₄₂)·G₅₂^{T}(ψ₅₂)·D₃·G₄₃^{T}(ψ₄₃)·G₅₃^{T}(ψ₅₃)·D₄·G₅₄^{T}(ψ₅₄)·Ĩ_{5×5} (17)

To retrieve the first column of V, it is enough to use the values that perform direct modifications through conditioning and Givens rotation to this column, i.e. the angles iv corresponding to the matrix D₁ and the rotation angles φ associated to the element (1,1). The other columns show different values. Equation 18 shows the operation to retrieve the first column in this particular example.

[Equation 18]

\tilde{V}₁_{^{st}}_{column}=V₁_{^{st}}_{column}·\tilde{D}*=·D₁·G₂₁^{T}(ψ₂₁)·G₃₁^{T}(ψ₃₁)·G₄₁^{T}(ψ₄₁)·G₅₁^{T}(ψ₅₁)·Ĩ_{5×5} (18)

To retrieve the second column, the necessary angles are those directly affecting the second column, i.e. the angles ψ from D₂ and the rotation angles φ associated to the element (2,2), and the angles required to perform the previous steps. In this case, columns 1 and 2 are totally retrieved, but the other columns show different values. Equation 19 shows the operation to retrieve the second column in this particular example.

[Equation 19]

\tilde{V}₂_{^{nd}}_{column}=V₂_{^{nd}}_{column}·\tilde{D}*=·D₁·G₂₁^{T}(ψ₂₁)·G₃₁^{T}(ψ₃₁)·G₄₁^{T}(ψ₄₁)·G₅₁^{T}(ψ₅₁)·D₂·G₃₂^{T}(ψ₃₂)·G₄₂^{T}(ψ₄₂)·G₅₂^{T}(ψ₅₂)·Ĩ_{5×5} (19)

In general, to retrieve a given column from the precoding matrix V, the minimum required angles are angles ψ and φ affecting that column directly and the angles corresponding to the previous steps.

When more than one stream is required (i.e. more than one column must be preserved), the angles to be sent are those allowing the recovery of the most stringent stream, as its recovery necessarily implies the recovery of the other required columns.

Equation 20 shows the feedback size for the selected “complementary” version of the compressed feedback.

[Equation 20]

feedback_{compressed}_{_{SELECTED-COMPLEMENTARY}}=N_{S}(Nₐ_{_{SELECTED}}·(b_{ψ}_{_{COMPLEMENTARY}}+b_{φ}_{_{COMPLEMENTARY}})/2) (20)

In the above equation, Na_{SELECTED} gives the number of angles necessary to allow the recovery of the columns associated to the streams for which “complementary” feedback is to be given.

In the case of compressed MU-MIMO feedback, the process is the same as in the case of compressed feedback. The MU-Exclusive Beamforming Report is included into the “rough” feedback; therefore, the “complementary” feedback calculation is analogous.

### Embodiment 3

Another embodiment of this invention is a system in which AP 101b of Embodiment 3, in order to perform SU-MIMO communication with one of its associated STAs, requests first the transmission of “rough” feedback, then AP 101b selects the streams it wants to use for the MIMO communication, and requests the “complementary” feedback for those selected streams to the STA.

### Embodiment 4

Another embodiment of this invention is a system as the one described in the embodiment 3 in which AP 101c of Embodiment 4 requests “rough” feedback to a STA and evaluates it in Feedback Analyzer module. If the quality is not good enough and there are more STAs in the BSS, AP 101c tries a different STA. If the quality of the link is satisfactory, or there are no more STAs in the BSS, or no other STA presented better values in recent polls, AP 101c selects the streams it wants to use for the communication and requests its “complementary” feedback.

When AP 101c requests feedback from a STA, AP 101c stores these values in memory for reference. If all the STAs in BSS 1 with pending transmission data except one have been polled by AP 101c within the coherence time of the system and no STA showed a satisfactory link quality, AP 101c will request feedback from the remaining STA and transmit to it regardless of its link quality.

### Embodiment 5

Another embodiment of the invention is the system of the embodiment 1 or 2 in which the STAs can reply with normal one step feedback even when AP 101d of Embodiment 5 requests “rough” feedback, due to incompatibility with the two step “rough” and “complementary” feedback mechanic, or due to other reasons that may force a capable STA to revert to a legacy feedback scheme.

### Embodiment 6

Another embodiment of the invention is an OFDMA system in which the feedback (for one or more streams) is given divided into frequency subbands. Following the spirit of this invention, the STA (or STAs) give AP 101e of Embodiment 6 the rough feedback pertaining to each subband, AP 101e decides which subband it wants to use to transmit to each STA, and communicates that decision, requesting complementary feedback for those streams and subbands.

The embodiments of the invention include any kind of program that, exerting control over AP, realizes the functions related to the invention described in the embodiments by, for example, controlling the operation of a CPU (Central Processing Unit). The information used by this terminal, as well as the results of its processing, can be stored in RAM (Random Access Memory) to be later stored in a more permanent solution such as Flash ROM (Read Only Memory) or other kinds of ROMs or HDDs (Hard Disk Drive). Said information can be read from that memory as needed by the CPU, which has the ability to correct or overwrite that data.

In order to realize all the functions described in this embodiment of the invention, the information is registered in a storage medium that can be read by a computer. The computer is able to access this information and load it into the computer system, carrying out the processing identified with each module. Furthermore, in this text, “computer system” includes the operating system and all the required hardware.

“A storage medium that can be read by a computer” can be a flexible disk, a magnetic or optic disk, a ROM, a CD-ROM, a portable device with storage capabilities, etc. It is any kind of storage device that can be connected to the computer system. Furthermore, “storage medium that can be read by a computer” also includes any way of sending the program in a sufficiently short time through the Internet, a network, a telephone circuit, etc. in a way such that the program is dynamically maintained in the pair server-client. The above stated program includes any device conceived in order to perform part of the previously mentioned functions, as well as any computer system in which the previously mentioned functions are already embedded, providing the capability of performing any combination of them. The embodiment also includes any integrated circuit that can carry out part or all of the functionalities described in the communications systems above (related to either transmission or reception). A microchip being able to perform part or all of the above described individual diagram blocks of communications system is also considered. This description is not limited to specific purpose integrated circuits (for instance LSI or VLSI), but also includes more general purpose devices that perform these operations. It is also possible to substitute the semiconductors present in the integrated circuits with any other material that allows the above described operations. That is also included in the present invention.

Although the above text references the figures to give a detailed explanation of an example configuration of this invention, it is not limited to it. Any possible configuration that changes the blocks but does not deviate from the main point and idea of this document is included.

### INDUSTRIAL APPLICABILITY

The embodiments of the invention can be used in a MIMO communication.

### REFERENCE SIGNS LIST

201: Rough quantized value (Q_{rough} bits)
202: Complementary quantized value (Q_{complementary} complementary bits)
203: Full quantized value (Q_{full} bits)
301: NDPA (No Data Packet Announce) indicating rough feedback
305: FBP (Feed Back Packet) requesting complementary feedback

1. (canceled)

2. A mobile station device which communicates with a base station device in a MIMO communication comprising
a feedback creation module and a complementary feedback storage module, wherein
the feedback creation module creates a first feedback information comprising the most significant bits of the channel state information and a second feedback information comprising the remaining bits;
the second feedback information is stored in the complementary feedback storage module;
the mobile station device transmits the first feedback information to the base station device;
the mobile station device further transmits the second feedback information to the base station device upon being requested to do so by the base station device.

3. The mobile station device according to claim 2,
wherein the mobile station device receives a request for the second feedback information corresponding to a subset of the streams between the mobile station device and the base station device,
the mobile station device transmitting only the second feedback information of the indicated streams.

4. The mobile station device according to claim 2,
wherein the mobile station device receives a request for the second feedback information corresponding to a subset of subcarriers of one or more of the streams between the mobile station device and the base station device,
the subset of subcarriers of each requested stream being unrelated to the subset of subcarriers requested for each other stream,
the mobile station device transmitting only the second feedback information of the indicated subset of subcarriers of the indicated streams.

5. A base station device which communicates with one or more mobile station devices in a MIMO communication comprising
a complementary feedback storage module and a feedback reconstruction module, wherein
the base station device receives a first feedback information from each mobile station device and stores it in the feedback storage module;
the base station device selects a set of mobile station devices to be part of an MU-MIMO group based on the first feedback information of all the mobile station devices;
the base station device requests a second feedback information to the mobile station devices belonging to the MU-MIMO group;
the base station device receives a second feedback information from each mobile station device belonging to the MU-MIMO group and stores it in the feedback storage module,
the base station device combining the first feedback information and the second feedback information of each mobile station device to obtain the channel state information of each mobile station device,
the base station device performing MIMO transmission based on the channel state information of all the mobile station devices.

6. The base station device according to claim 5,
characterized in that the base station device selects a subset of individual streams from one of the antennas of the base station device to one of the antennas of a mobile station device,
the base station device requests a second feedback information for the selected streams to the terminal stations corresponding to the selected streams.

7. The base station device according to claim 5,
characterized in that the base station device selects a subset of subcarriers of one or more of the streams between the mobile station device and the base station device,
the subset of subcarriers of each requested stream being unrelated to the subset of subcarriers requested for each other stream,
the base station device requests a second feedback information for the selected streams to the terminal stations corresponding to the subset of subcarriers of the selected streams.

8. A MIMO communication method between a base station device and one or more mobile station devices, wherein
the mobile station devices transmit a first feedback information to the base station device,
the first feedback information comprising the most significant bits of the channel state information between each mobile station device and the base station device;
the base station device selects a set of mobile station devices to be part of an MU-MIMO group based on the first feedback information of all the mobile station devices;
the base station device requests a second feedback information to the mobile station devices belonging to the MU-MIMO group;
the mobile station devices receiving a request for a second feedback information transmit a second feedback information to the base station device,
the second feedback information comprising bits of the channel state information that are not transmitted in the first feedback information.

9. A MIMO communication method according to claim 8,
characterized in that the base station device selects a subset of individual streams from one of the antennas of the base station device to one of the antennas of a mobile station device,
the base station device requesting a second feedback information for the selected streams to the terminal stations corresponding to the selected streams,
the mobile station devices receiving a request for a second feedback information for a stream transmitting a second feedback information for the stream to the base station device,
the second feedback information comprising bits of the channel state information that are not transmitted in the first feedback information.

10. A MIMO communication method according to claim 8, characterized in that the base station device selects a subset of individual streams from one of the antennas of the base station device to one of the antennas of a mobile station device,
the base station device further selecting a set of subcarriers for each stream,
the base station device requesting a second feedback information for the selected subcarriers of the selected streams to the terminal stations corresponding to the selected streams,
the mobile station devices receiving a request for a second feedback information for a group of subcarriers of a stream transmitting a second feedback information for the group of subcarriers of the stream to the base station device,
the second feedback information comprising bits of the channel state information that are not transmitted in the first feedback information.

11. A MIMO communication method according to claim 8, characterized in that at least one of the mobile station devices is a normal one which has not the capability of transmitting a first feedback information and a second feedback information, wherein
the mobile station device sends the channel state information to the base station device instead of a requested first feedback information, and
the base station device acknowledges the transmission of channel state information instead of first feedback information and uses it instead to perform the terminal station selection for the MU-MIMO group,
the base station device not requesting any further feedback to the mobile station device if the mobile station device is part of the MU-MIMO group.
